(19) United States
(12) Patent Application Publication
(10) Pub. No.: US 2026/0230464 A1
(43) Pub. Date: Aug. 6, 2026

(54) METHOD FOR REVOKING A CERTIFICATION TOKEN FOR AUTHENTICATING THE ESTABLISHMENT OF A CONNECTION BETWEEN TWO COMMUNICATION DEVICES, CORRESPONDING DEVICES AND COMPUTER PROGRAMS

(71) Applicant: Orange, Issy-Les-Moulineaux (FR)

(72) Inventors: Emile STEPHAN, Chatillon Cedex (FR); Romuald CORBEL, Chatillon Cedex (FR); Gaël FROMENTOUX, Chatillon Cedex (FR); Frédéric FIEAU, Chatillon Cedex (FR)

(21) Appl. No.: 19/151,251

(22) PCT Filed: Jan. 19, 2024
(86) PCT No.: PCT/EP2024/051284

§ 371 Date: Jul. 25, 2025

(30) Foreign Application Priority Data
Jan. 25, 2023 (FR) FR2300702

(51) Int. Cl. H04L 9/40

(52) U.S. Cl. CPC H04L 63/0823; H04L 63/083

(57) ABSTRACT

A solution for revoking a certificate supplied to a device in an edge computing environment. Existing authentication solutions are not well suited to the context of edge computing since they cannot meet the demands required to manage these items of equipment which may be deployed in distributed infrastructures, but which may be reconfigured, suspended, removed, reactivated or even reassigned to another master node depending on the demands to be met. The present solution makes it possible, by reusing components that are already present in a communication network, to revoke a certificate whose integrity cannot be called into question since the trusted third party issuing the certificate is the operator managing the communication network.

### CROSS-REFERENCE TO RELATED APPLICATIONS

This application is filed under 35 U.S.C. § 371 as the U.S. National Phase of Application No. PCT/EP2024/051284 entitled “Method for revoking a certification token for authenticating the establishment of a connection between two communication devices, and corresponding devices and computer programs” and filed Jan. 19, 2024, and which claims priority to FR2300702 filed Jan. 25, 2023, each of which is incorporated by reference in its entirety.

### BACKGROUND

### Field

The field of the development is that of the certification of a device connected to a communication network. More specifically, the development relates to a solution for managing the revocation of a certificate associated with a device in an “edge computing” type environment.

### Description of the Related Technology

A new stage in the development of “cloud computing” has emerged in recent years. This new development is called “edge computing” and involves processing data at the edge of the network the closest to the source of the data.

Thus, “edge computing” allows minimizing the needs in terms of bandwidth between devices, such as sensors, and data processing centers by undertaking analyses the closest to the data sources. This approach requires the mobilization of resources that may not be permanently connected to a network, such as laptops, smartphones, tablets, or sensors. “Edge computing” also plays a leading role in content ingestion and delivery solutions. In this respect, many content delivery network CDN (Content Delivery Network) architectures are based on “edge computing” type architectures.

A known implementation of such an “edge computing” type architecture is an architecture known as Kubernetes.

FIG. 1 shows in a simplified manner the architecture of a node cluster 1 compliant with the Kubernetes solution. The node cluster 1 comprises a first node 10 called a management node, or “Kubernetes master”, and N compute nodes, or “workers node”, 11ᵢ, iϵ{1, . . . , N}, N being a natural integer.

The management node 10 comprises a controller 101, an API (Application Programming Interface) module 102 and a database 103 called ETCD (name of the Kubernetes main database, storing the configurations of the distributed systems or machine clusters) which consists of a dynamic register of configuration of the compute nodes 11ᵢ.

A compute node 11ᵢ comprises M containers or “pods” 110ⱼ, jϵ{1, . . . , M}, M being a natural integer. Each container 110ⱼ is provided with resources for executing one or more tasks. When executed, a task contributes to the implementation of a network service or function, such as a DHCP (Dynamic Host Configuration Protocol) function for example.

With a view to reducing costs and improving the flexibility of network infrastructures, “edge computing” architectures are most often multi-site architectures in which the nodes making up the node clusters may be not co-located. For example, a management node 10 and two compute nodes 11₁, 11₂ of a node cluster 1 are located at a site A while three other compute nodes 11₃, 11₄, 11₅ are located at a remote site B.

Existing authentication solutions, such as the https (HyperText Transfer Protocol Secure) protocol, which is based on the introduction of an encryption layer compliant with the TLS (Transport Layer Security) protocol family, are not well suited to the context of “edge computing”. This family comprises SSL (Secure Socket Layer) protocols, TLS, cTLS, QUIC, MASK, DTLS, LAKE EDDOC, TLS on COAP variants . . . ), etc.

The https protocol makes it possible for a device of a visitor, such as a personal computer, to verify the identity of a website that the visitor desires to access from the device thereof.

Thus, the device verifies the identity of a server hosting the website, thanks to a public authentication certificate of the X509 type issued by a third-party authority, deemed reliable, to a server providing a service. Such a certificate guarantees the confidentiality and integrity of the data transmitted by the visitor to the server providing a service.

Such an operating mode, namely the verification of the identity of a device with which a communication session is intended to be established, cannot meet the needs required by the management of the compute nodes. Indeed, such a management is complex because the compute nodes may be deployed in distributed, or even private or even mobile infrastructures, but above all they may be reconfigured, suspended, removed, reactivated or even reassigned to another node cluster according to the needs to be met. Each of these operations may call into question the validity of the certificates associated with the compute nodes.

In addition, the compute nodes correspond, from a protocol point of view, to the visitor device described in the example described above. Consequently, one could therefore see that the application of the https solution to an “edge computing” architecture is not suitable.

Hence, there is a need to provide a solution for managing devices belonging to an “edge computing” type architecture that does not present all or part of the aforementioned drawbacks.

### SUMMARY

The development partially meets this need by proposing a method for revoking a first certification token corresponding to a first certificate, said first certification token for authenticating the establishment of a connection between a device connected to at least one communication network and at least one server of a service provider, said first certification token and said first certificate being generated from a hash of a physical address of said device, a certificate associated with a network address configuration server and at least one network address allocated to said device by said network address configuration server.

Such a method is particular in that it comprises the following steps implemented by a certificate management module:
revoking said first certification token triggered by obtaining information relating to a condition to revoke said first certification token,
transmitting, to a domain name server, a request to revoke an association established between on the one hand the first certificate and the first certification token and on the other hand at least one domain name

The solution, object of the present development, makes it possible to revoke a certificate systematically when the device is reconfigured, when the certificate thereof is suspended, corrupted, when a lease associated with the network address allocated to the device expires or when an association established between on the one hand the first certificate and the first certification token and on the other hand at least one domain name also expires.

The present solution proposes to revoke a certification token corresponding to a certificate associated with the device for reducing the number of exchanges relating to the management of this certificate for such a device, which is particularly interesting in an edge computing context where agility is essential.

Such a certificate management module may be co-located with the configuration server or with the domain name server, wherein an association of said certificate with at least one domain name provided by the configuration server is stored.

Finally, knowing that the device can be allocated a plurality of network addresses, or “address pool”, the first certification token is associated with all or part of this address pool. Similarly, the same device can have a plurality of certificates and corresponding certification tokens simultaneously.

Such a configuration token makes it possible to verify the authenticity and integrity of a certificate associated with the device and thus authorize the establishment of a connection with the device. For example, establishing such a connection corresponds to integrating the device into a Kubernetes architecture as a compute node.

According to one particularity of the revocation method, said condition to revoke said first certification token belongs to a group comprising:
a request to revoke said first certification token, said revocation request being transmitted by the device,
a request to revoke said first certification token, said revocation request being transmitted by a device of the network
an expiry of an allocation period of the network address allocated to the device,
an expiry of a lifetime of the first certification token,
a conflict of use in an addressing plan,
information relating to a compromise of the first certification token,
information relating to a piracy of the first certification token.

In one example of implementation, when the information relating to a condition to revoke said first certificate is information relating to the expiry of the duration of the association established between, on the one hand, the first certificate and the first certification token and, on the other hand, at least one domain name, the revocation method comprises, prior to the step of revoking the first certification token, the following steps of:
transmitting a request to revoke an association established between, on the one hand, the first certificate and the first certification token and, on the other hand, the network address configuration server,
receiving a request to revoke said first certification token transmitted by said network address configuration server following the revocation of the association established between, on the one hand, the first certificate and the first certification token and, on the other hand, the network address configuration server.

In such an example of implementation, the revocation of the certification token occurs when a resolution of the domain name is required. This contributes to reducing the load on the communication network.

Once the certification token has been revoked, the revocation method implements a step of transmitting, to the network address configuration server, a message acknowledging the revocation of said first certification token by the certificate management module.

Thus, the network address configuration server can release the network address associated with the device whose certification token has just been revoked.

The revocation method may also comprise the following steps when the condition for revoking said first certification token is accompanied by a request to replace said first certification token:
generating a second certificate associated with said device and a second corresponding certification token,
transmitting, to said domain name server, a request to associate said second certificate and said second certification token to said domain name previously associated with the first certificate and with the corresponding first certification token,
transmitting said second certification token to said device.

Such an example is of interest when the validity of the certification token expires but also when the certificate associated with the device is corrupted or has been hacked. In such a case, the connection established between the device and the server of the service provider is maintained and the second certification token is transmitted to the device through this connection making the operation transparent for a user of the device. The generation of this second certification token in replacement of the first certification token activates a specific connection management mechanism such as monitoring the use of this second certification token whose purpose is to monitor and examine the exchanges occurring between the device and the server of the service provider in order to determine the corrupt nature of the connection.

This results, for example, in slowing down exchanges initiated by the server through the connection in order to keep it active for longer so that it can be observed over a longer period of time.

Again in this example, the second certification token can also offer restricted access to resources of the server of the service provider.

Thus, the second certification token contributes to the implementation of a “sandbox” by limiting access of the device to some services or by isolating the traffic related to this service to or from the device.

In order to further isolate the traffic linked to the device, the method further comprises a step of transmitting, to the network address configuration server, a supply request, said device, of at least one network address pointing to a host machine acting as a fictitious server of the supplier.

In this case, the network address provided to the device is a so-called black hole network address that does not allow traffic to be routed to the device or does not allow traffic to be transmitted from the device to the server of the service provider but indicates to a router that this traffic can be routed to another dedicated device suitable for processing data from/intended for a potentially corrupted device, or that this traffic may not be routed at all.

The development also relates to a certificate management module adapted to revoke a first certification token corresponding to a first certificate, said first certification token for authenticating the establishment of a connection between a device connected to at least one communication network and at least one server of a service provider, said first certification token and said first certificate being generated by said certificate management module from a hash of a physical address of said device, a certificate associated with a network address configuration server and at least one network address allocated to said device by said network address configuration server, said certificate management module comprising at least one processor configured to:
revoke said first certification token following obtaining information relating to a condition to revoke said first certification token,
transmit, to a domain name server, a request to revoke an association established between the first certificate, the first certification token and at least one domain name.

Another object of the development is a network address configuration server comprising at least one certificate management module adapted to revoke a first certification token corresponding to a first certificate, said first certification token for authenticating the establishment of a connection between a device connected to at least one communication network and at least one server of a service provider, said first certification token and said first certificate being generated by said certificate management module from a hash of a physical address of said device, a certificate associated with said network address configuration server and at least one network address allocated to said device by said network address configuration server, said certificate management module comprising at least one processor configured to:
revoke said first certification token following obtaining information relating to a condition to revoke said first certification token,
transmit, to a domain name server, a request to revoke an association established between the first certificate, the first certification token and at least one domain name.

Finally, the development relates to a computer program product comprising program code instructions for the implementation of a method as described previously, when it is executed by a processor.

Another aim of the development is a computer-readable recording medium on which a computer program is recorded comprising program code instructions for the execution of the steps of the method according to the development as described hereinabove.

Such a recording medium may be of any entity or device able to store the program. For example, the medium may comprise a storage means, such as a ROM, for example a CD-ROM or a ROM of a microelectronic circuit, or also a magnetic recording means, for example a USB key or a hard disk.

Moreover, such a storage medium may be a transmissible medium such as an electrical or optical signal, which can be conveyed via an electrical or optical cable, by radio or by other means, so that the computer program contained therein is remotely executable. In particular, the program according to the development may be downloaded on a network, for example the Internet network.

Alternatively, the recording medium may be an integrated circuit wherein the program is incorporated, the circuit being adapted to execute or to be used in the execution of the method that is the aforementioned object of the development.

### BRIEF DESCRIPTION OF THE DRAWINGS

Other aims, features and advantages of the development will become more apparent upon reading the following description, given simply by way of illustrative and non-limiting example, with reference to the figures, wherein:

FIG. 1: this figure shows in a simplified manner the architecture of a node cluster 1 compliant with the Kubernetes solution,

FIG. 2: this figure shows a system wherein the present solution can be implemented,

FIG. 3A: this figure shows the various steps implemented during the execution of a first embodiment of the methods object of the present development leading to obtaining the certification token within the system of FIG. 2,

FIG. 3B: this figure shows the various steps implemented during the execution of a second embodiment of the methods object of the present development leading to obtaining the certification token within the system of FIG. 2,

FIG. 4: this figure shows the continuation of the steps of the methods relating to the use of the certification token CNT by a device belonging to the system of FIG. 2,

FIG. 5: this figure shows the various steps implemented by the various devices constituting the system described with reference to FIG. 2 in a first embodiment of the method for revoking a certification token according to the development,

FIG. 6: this figure shows the various steps implemented by the various devices constituting the system described with reference to FIG. 2 in a second embodiment of the method for revoking a certification token according to the development,

FIG. 7: this figure shows the various steps implemented by the various devices constituting the system described with reference to FIG. 2 in a third embodiment of the method for revoking a certification token according to the development,

FIG. 8: this figure shows the various steps implemented by the various devices constituting the system described with reference to FIG. 2 in a fourth embodiment of the method for revoking a certification token according to the development,

FIG. 9: this figure shows a device capable of implementing the method for authenticating the establishment of a connection between a device connected to at least one communication network and a server of a service provider object of the present development,

FIG. 10: this figure shows a management module capable of implementing the various methods object of the present development.

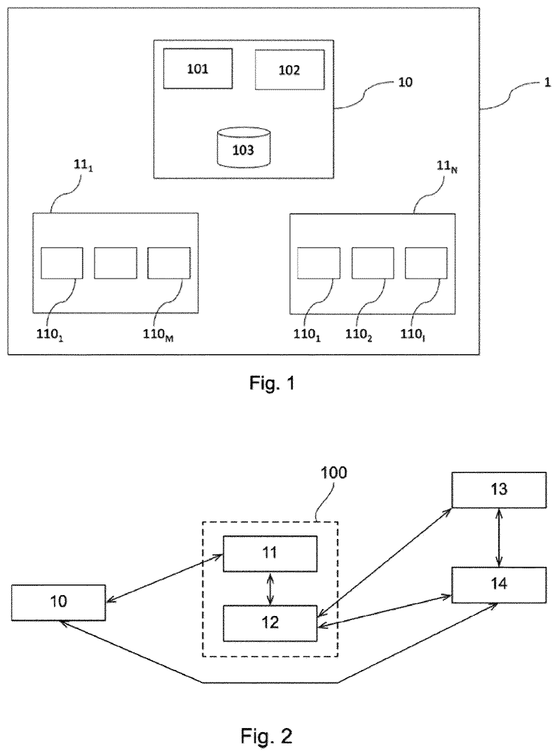

### DETAILED DESCRIPTION OF CERTAIN ILLUSTRATIVE EMBODIMENTS

The general principle of the development relates to the management of a certificate, in particular yet not exclusively, for a device located in an “edge computing” type environment during the operation of said device. The development proposes a mechanism for revoking a certification token corresponding to a certificate associated with said device. This revocation mechanism makes it possible to revoke a certificate associated with the device, for example when the device is reconfigured, when the certificate thereof is suspended, corrupted, when a lease associated with the network address allocated to the device expires or when an association established between on the one hand the first certificate and the first certification token and on the other hand at least one domain name also expires, etc.

Such a solution has the advantage of being fast, which makes it particularly interesting for architectures requiring frequent dynamic configurations. Indeed, this allows reducing the number of exchanges and the amount of processing operations relating to the management of this certificate for such a device, which is particularly interesting in an “edge computing” context where agility is essential.

We now present, in relation to FIG. 2 a system wherein the present solution may be implemented.

Such a system comprises at least one device 10 connected to at least one communication network (not shown in the figures), at least one network address configuration server 11, such as a DHCP (Dynamic Hosts Configuration Protocol) server, at least one certificate management module 12, at least one domain name server 13 such as a DNS server and at least one server of a service provider 14, independent or not, of the operator of the communication network.

The device 10 may also be either a mobile terminal, a server, a node, or a container according to the Kubernetes solution, or a sensor. It may also consist of a virtualized device.

In the remainder of the document, the configuration server 11 has the identifier ‘srvcfg11’ and belongs to a communication network whose domain name is ‘example.com’, the “Common Name” CN or the “Fully Qualified Domain Name” FQDN associated with the certificate CertDHCP of the configuration server 11 is ‘srvcfg11.example.com’.

In one example of implementation, the configuration server 11 and the certificate management module 12 may be co-located in the same device 100 as shown in FIG. 2. In another example of implementation, the certificate management module 12 may be co-located with the domain name server 13 or integrated therein. In yet another example of implementation, the certificate management module 12 may be physically separated from the configuration server 11 and the domain name server 13.

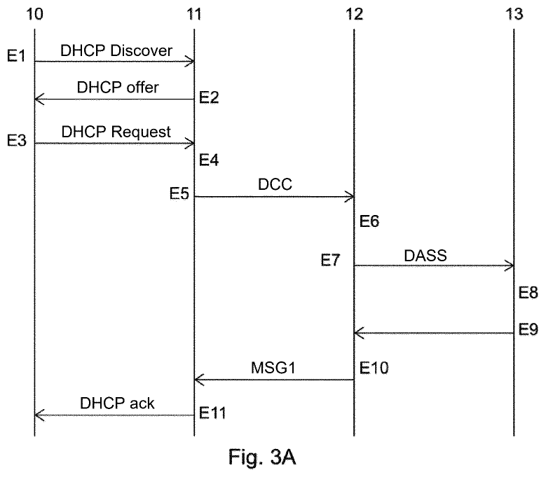

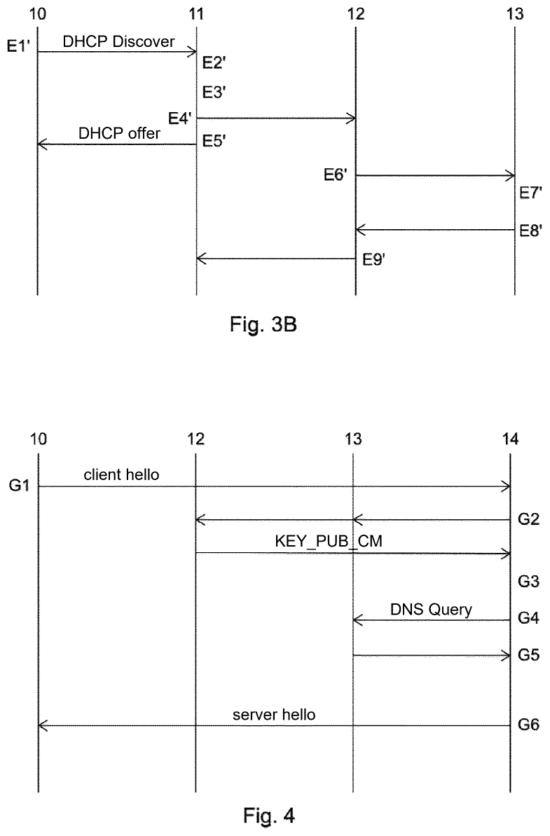

With reference to the system described in FIG. 2, a first part of the sequence of the methods leading to obtaining such a certification token is now described, followed by the method for revoking the certification token object of the development. The various steps implemented during the execution of a first embodiment of the methods leading to obtaining the certification token within the previously described system are shown in the form of a diagram in FIG. 3A.

In a step E1, the device 10 seeks to connect to a communication network. To this end, the device 10 sends a DHCP Discover request to the configuration server 11 so that the latter allocates thereto one or more network address(es) such as IPv4 or IPv6 addresses.

In a step E2, upon reception of the DHCP Discover request transmitted by the device 10, the configuration server 11 conventionally proposes one or more network address(es) to the device 10 via the transmission of a message of the DHCP offer type.

In another example, the configuration server 11 may implement an ACME-STAR type delegation method or a so-called “Delegated Credentials” method upon reception of the DHCP Discover request transmitted by the device 10. These methods are described in the document referenced Acme-Star RFC 8739 published by the IETF.

Thus, they enable the delegated device 10 to receive, here in a message of the DHCP Offer type, a temporary certificate possibly hash calculated based on a private key of the delegating configuration server 11.

In a step E3, the device 10 validates the proposed allocation of network addresses received during step E2 and transmits, to the configuration server 11, a DHCP Request validating network addresses among those proposed and comprising parameters relating to the creation of a certificate. Such parameters comprise, inter alia: a public key PUB_KEY_CPE of the device 10, a hash HASH_CPE of a physical address of the device 10 such as a MAC (Medium Access Control) address as well as a parameter TYP_HASH on the manner in which the hash HASH_CPE is calculated. These various parameters may be transmitted in the form of a certificate that may be hashed.

Upon reception of the DHCP Request request, in a step E4, the configuration server 11 processes the information relating to the allocation of network addresses included in this request in a conventional manner. When processing this DHCP Request request, the configuration server 11 detecting the presence of parameters relating to the creation of a certificate in a field of the DHCP Request request, i.e. the public key PUB_KEY_CPE, the hash HASH_CPE or the parameter TYP_HASH, extracts this information and generates a request to create a DCC certificate associated with the device 10.

The request to create a DCC certificate comprises: the public key PUB_KEY_CPE of the device 10, the hash HASH_CPE of a physical address of the device 10, a certificate CertDHCP associated with the configuration server 11, at least one network address IP_CPE allocated to said device 10 by the configuration server 11 during step E4 (or a pool of network addresses POOL_IP_CPE allocated to the device 10), and finally the parameter TYP_HASH on how the hash HASH_CPE is calculated. The request to create a DCC certificate may a domain also comprise name, for example “4d2a.37f78dd8d99b3c75ddde3624155.example.com”, with which the certificate is intended to be associated.

In a step E5, the configuration server transmits the request to create a DCC certificate to the certificate management module 12.

Upon receiving the request to create a certificate associated with the device 10, the certificate management module 12 generates, during a step E6, a certificate CERT_CPE associated with the device 10 from the information included in the creation request DCC.

Such a certificate CERT_CPE corresponds to a network address allocated to the device 10. Thus, the certificate management module 12 creates as many certificates CERT_CPE associated with the device 10 as it has network addresses. In another example of implementation, the certificate management module 12 creates a single certificate CERT_CPE associated with the device 10 that applies to the network address pool POOL_IP_CPE allocated to the device 10. Such a certificate CERT_CPE includes the values of the physical address of the device 10 and of one or more network addresses chosen during step E3 by the device 10, in fields of the certificate CERT_CPE such as the Common Name (CN) or SAN fields for example.

The certificate management module 12 also generates a certification token CNT (Certificate Network Token) corresponding to the certificate CERT_CPE associated with the connectivity of the device 10 to the network of 11. Such a certification token CNT is a compact form of the certificate CERT_CPE associated with the device 10. More particularly, this certification token CNT comprises, inter alia, information relating to the hash HASH_CPE of the physical address of the device 10, to the HASH_CERT_CPE of the certificate CERT_CPE associated with the device 10, and an identifier CN_CM of the certificate management module 12. It is the certification token CNT or a hash HASH_CNT of the certification token CNT that will be used by the device 10 in all situations where the latter must provide authentication hardware to access a service. As the certification token CNT is a compact form of the certificate CERT_CPE associated with the device 10, it can be introduced into many existing messages without increasing the payload of the latter in a detrimental manner. In order to further limit the payload of the existing messages, the device 10 can transmit the hash of the certification token HASH_CNT instead of the certification token CNT. Thus, the implementation of the solution object of the present development does not introduce an excessively heavy load into a communication network.

The hash of the certification token HASH_CNT is calculated by means of a parameter TYP_HASH_CNT. In the remainder of the document, the value of the hash of the certification token HASH_CNT is “37f78dd8d99b3c75ddde3624155”, and the value of the parameter TYP_HASH_CNT is 4D2A.

Thus, for example, the certification token CNT corresponding to the certificate CERT_CPE of the device 10 has the value “4D2A.37f78dd8d99b3c75ddde3624155”, and the Common Name (CN) field of the certificate CERT_CPE of the device 10 comprises the values “4D2A. 37f78dd8d99b3c75ddde3624155.srvcfg1.example.com”.

In a step E7, the certificate management module 12 transmits a request for association DAss of the certificate CERT_CPE associated with the device 10 thus generated with the domain name “4d2a.37f78dd8d99b3c75ddde3624155.example.com” with which the certificate CERT_CPE is intended to be associated to the domain name server 13.

Such an association request DAss comprises: the certificate CERT_CPE associated with the device 10, the corresponding certification token CNT, a hash HASH_CNT of the certification token CNT and a parameter TYP_HASH_CNT on how the hash HASH_CNT is calculated. In one example of embodiment, the parameter TYP_HASH_CNT on how the hash HASH_CNT is calculated may comprise a public key of the certificate management module 12.

In a step E8, the domain name server 12 records all of the information included in the association request DAss in a table and associates them with the domain name “4d2a.37f78dd8d99b3c75ddde3624155.example.com”.

Optionally, once the association between all the information included in the association request DAss and the domain name has been performed, the domain name server 13 informs the certificate management module 12 thereof in a step E9.

In turn, the certificate management module 12 informs the configuration server 11 on the creation of the certificate CERT_CPE associated with the device 10 in a step E10. For this purpose, the certificate management module 12 transmits to the configuration server 11 an MSG1 message comprising the certification token CNT corresponding to the certificate CERT_CPE associated with the device 10, the hash HASH_CNT of the certification token CNT and the parameter TYP_HASH_CNT on how the hash HASH_CNT is calculated. Such a step E10 is optional.

Finally, the configuration server 11 sends, in a step E11, a message for assigning a network or update address, for example DHCP ‘renew’, or a new DHCP ‘update’ message, containing the CNT. In an existing or new field of this DHCP message, the configuration server 11 adds the certification token CNT corresponding to the certificate CERT_CPE associated with the device 10, the hash HASH_CNT of the certification token CNT and the parameter TYP_HASH_CNT on the manner in which the hash HASH_CNT is calculated. In another example of implementation of step E11, the configuration server 11 transmits only the hash of the certification token HASH_CNT and the parameter TYP_HASH_CNT on how the hash HASH_CNT is calculated in the assignment message.

At the end of step E11, the device 10 thus has a certification token CNT that will be used by the device 10 in all situations where the latter must provide authentication hardware to access a service. One should remark that the device 10 does not have its certificate CERT_CPE and does not know the domain name “4d2a.37f78dd8d99b3c75ddde3624155.example.com” associated with its certificate CERT_CPE. These two pieces of information are only stored in the domain name server 12.

With reference to the system described in FIG. 2, a first part of the sequence of the methods leading to obtaining such a certification token is now described, followed by the method for revoking the certification token object of the development. The various steps implemented during the execution of a second embodiment of the methods leading to obtaining the certification token within the previously described system are shown in the form of a diagram in [FIG. 3B].

In a step E1′, the device 10 seeks to connect to a communication network. To this end, the device 10 sends a DHCP Discover request to the configuration server 11 so that the latter allocates thereto one or more network address(es) such as IPv4 or IPv6 addresses. The DHCP Discover request comprises parameters relating to the creation of a certificate. Such parameters comprise, inter alia: a public key PUB_KEY_CPE of the device 10, a hash HASH_CPE of a physical address of the device 10 such as a MAC (Medium Access Control) address as well as a parameter TYP_HASH on the manner in which the hash HASH_CPE is calculated. These various parameters may be transmitted in the form of a certificate that may be hashed.

In a step E2′, the configuration server 11 selects at least one network address to be allocated to said device 10 and implements an ACME-STAR type delegation method or a so-called “Delegated Credentials” method as soon as the DHCP Discover request transmitted by the device 10 is received.

Such methods are described in the documents referenced Acme-Star RFC 8739 and “draft-IETF-TLS-subcerts-15-Delegated Credentials for (D) TLS” published by the IETF.

Upon reception of the DHCP Request request, in a step E3′, the configuration server 11 processes the information relating to the allocation of network addresses included in this request in a conventional manner. When processing this DHCP Request request, the configuration server 11 detecting the presence of parameters relating to the creation of a certificate in a field of the DHCP Request request, i.e. the public key PUB_KEY_CPE, the hash HASH_CPE and the parameter TYP_HASH, extracts this information and generates a certificate CERT_CPE associated with the device 10 based on this information.

Such a certificate CERT_CPE corresponds to a network address allocated to the device 10. Thus, the configuration server 11 creates as many certificates CERT_CPE associated with the device 10 as the latter has network addresses. In another example of implementation, the configuration server 11 creates a single certificate CERT_CPE associated with the device 10 that applies to the network address pool POOL_IP_CPE allocated to the device 10. Such a certificate CERT_CPE includes the values of the physical address of the device 10 and of one or more network addresses selected during step E3′ per configuration server 11, in a field of the certificate CERT_CPE such as the SAN field for example.

The configuration server 11 also generates a certification token CNT (Certificate Network Token) corresponding to the certificate CERT_CPE associated with the connectivity of the device 10 to the communication network. Such a certification token CNT is a compact form of the certificate CERT_CPE associated with the device 10. More particularly, this certification token CNT comprises, inter alia, information relating to the hash HASH_CPE of the physical address of the device 10, the hash HASH_CERT_CPE of the certificate CERT_CPE associated with the device 10, and an identifier CN DHCP of the configuration server 11. The configuration server 11 also determines a hash of the certification token HASH_CNT by means of a parameter TYP_HASH_CNT.

As already specified, the hash of the certification token HASH_CNT has the value “37f78dd8d99b3c75ddde3624155”, and the parameter TYP_HASH_CNT has the value 4D2A.

Thus, for example, the certification token CNT corresponding to the certificate CERT_CPE of the device 10 has the value “4D2A.37f78dd8d99b3c75ddde3624155”, and the Common Name (CN) field of the certificate CERT_CPE of the device 10 comprises the values “4D2A. 37f78dd8d99b3c75ddde3624155.srvcfg1.example.com”.

It is the certification token CNT or a hash HASH_CNT of the certification token CNT that will be used by the device 10 in all situations where the latter must provide authentication hardware to access a service. As the certification token CNT is a compact form of the certificate CERT_CPE associated with the device 10, it can be introduced into many existing messages without increasing the payload of the latter in a detrimental manner. In order to further limit the payload of the existing messages, the device 10 can transmit the hash of the certification token HASH_CNT instead of the certification token CNT. Thus, the implementation of the solution object of the present development does not introduce an excessively heavy load into a communication network.

In a step E4′, the configuration server 11 transmits the certificate CERT_CPE thus created to the certificate management module 12 accompanied by the certification token CNT thereof, the hash HASH_CNT of the certification token CNT, the parameter TYP_HASH_CNT on how the hash HASH_CNT is calculated and a certificate CertDHCP associated with the configuration server 11. The transmission of the certificate CERT_CPE may also comprise a domain name, for example “4d2a.37f78dd8d99b3c75ddde3624155.example.com”, with which the certificate is intended to be associated.

The configuration server 11 transmits, during a step E5′ which may be implemented beforehand, concomitantly with or after step E4′, a message of the DHCP Offer type to the device 10 comprising the corresponding certification token CNT as well as the network address(es) that the configuration server 11 has allocated thereto during step E3′.

In a step E6′, the certificate management module 12 transmits a request DAss for associating the certificate CERT_CPE associated with the device 10 with the domain name “4d2a.37f78dd8d99b3c75ddde3624155.example.com” with which the certificate CERT_CPE is intended to be associated to the domain name server 13.

Such an association request DAss comprises: the certificate CERT_CPE associated with the device 10, the corresponding certification token CNT, the hash HASH_CNT of the certification token CNT and the parameter TYP_HASH_CNT on how the hash HASH_CNT is calculated. In one example of embodiment, the parameter TYP_HASH_CNT on how the hash HASH_CNT is calculated may comprise a public key of the configuration server 11.

In a step E7′, the domain name server 13 records all of the information included in the association request DAss in a table and associates them with the domain name “4d2a.37f78dd8d99b3c75ddde3624155.example.com”.

Optionally, once the association between all the information included in the association request DAss and the domain name has been performed, the domain name server 13 informs the certificate management module 12 thereof in a step E8′.

In turn, the certificate management module 12 informs the configuration server 11 of the association between all the information included in the association request DAss and the domain name in a step E9′.

At the end of step E9′, the device can use the certification token CNT in all situations where the latter must provide authentication hardware to access a service. It should be remarked that the device 10 does not have its certificate CERT_CPE and does not know the domain name “4d2a.37f78dd8d99b3c75ddde3624155.example.com” associated with its certificate CERT_CPE. These two pieces of information are only stored in the domain name server 12.

Now that the device 10 has a certification token CNT and/or a hash of the certification token HASH_CNT, it can establish a connection with a server of a service provider 14. [FIG. 4] shows the continuation of the steps of the methods relating to the use of the certification token CNT by the device 10.

The device 10 desiring to establish a connection with the server of a service provider 14 transmits to the latter a client Hello TLS message during a step G1. In an existing field of this client Hello TLS message, or in an extension TLS_CNT, the device 10 adds the certification token CNT, the hash HASH_CNT of the certification token CNT, and the parameter TYP_HASH_CNT on the manner in which the hash HASH_CNT is calculated. In practice, the certification token CNT can be transported by any secure exchange protocol of the TLS family or other, in a field of any application protocol such as HTTP transported below of any combination of protocols guaranteeing the integrity of the exchange, but also in an OAM (iOAM) field described in https://datatracker.ietf.org/doc/html/draft-ietf-ippm-ioam-data-17.txt. Thus, the certification token CNT can be transported, or updated at any time during the life of an exchange session between 10 and 14.

In a step G2, the server of a service provider 14 obtains the public key PUB_KEY_CM of the certificate management module 12. The public key PUB_KEY_CM is for example a public field of the certificate X509 of the certificate management module 12 obtained, after step G1 or prior to, for example, establishing a secure tunnel established between the server of a service provider 14 and the certificate management module 12, or pre-registered in the server of a service provider 14.

Using the public key PUB_KEY_CM of the certificate management module 12, the server of a service provider 14 proceeds, during a step G3, to verify the authenticity of the certification token CNT by means of the public key PUB_KEY_CM of the certificate management module 12 and the hash HASH_CNT of the certification token CNT and the information TYP_HASH_CNT on how the hash HASH_CNT is calculated.

Once this verification has been performed, the server of a service provider 14 asks, in a step G4, the domain name server to provide it with the certificate CERT_CPE associated with the certification token CNT that it has just verified. For this purpose, the server of a service provider 14 transmits a DNS Query type message comprising, in an existing field, the certification token CNT.

In a step G5, the domain name server 13 returns the certificate CERT_CPE corresponding to the certification token CNT received.

In a step G6, the server of a service provider 14 then verifies that the certificate CERT_CPE corresponds to the network address(es) provided in the client Hello TLS message knowing that such a certificate CERT_CPE is delivered for one or more network address(es) allocated to the device 10.

Once the device 10 has been authenticated, the server of a service provider 14 transmits a Server Hello message to the device 10 thereby finalizing the establishment of the connection between the latter and the server of a service provider 14 in a step G6. The service server 14 also adds the information ‘UE authenticated’ in the extension TLS_CNT of the Server Hello message thereby indicating that the device 10 is authenticated.

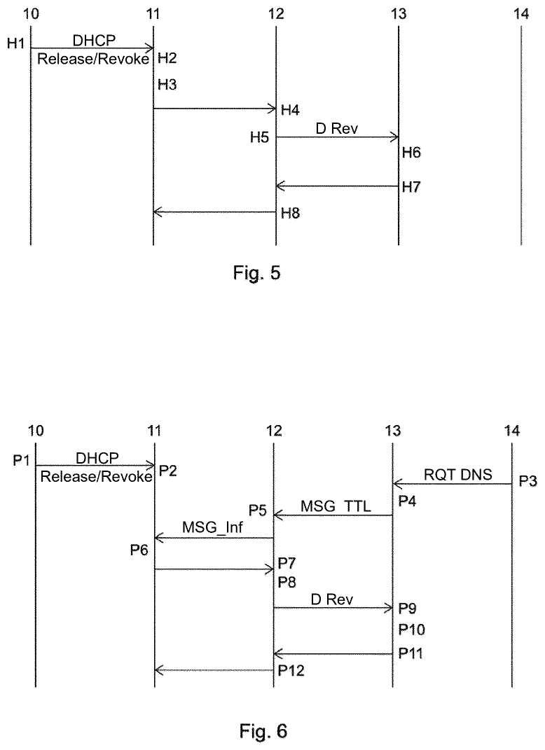

FIG. 5 shows the various steps implemented by the various devices constituting the system described with reference to FIG. 2 in a first embodiment of the method for revoking a certification token CNT associated with the device 10.

The implementation of this revocation method may or may not occur following the execution of step G6 during which a connection is established between the device 10 and the server of a service provider 14.

In a first implementation, the device 10 transmits, to the configuration server 11, a message requesting the release of the network address(es) allocated thereto during a step H1.

Sending such a message to the configuration server 11 may be triggered when the device 10 leaves the coverage area of a first access node, such as for example a Wi-Fi access node, to attach to a second access node such as a base station. Such an access network change requires the release of the network address allocated to the device 10, resulting in the revocation of the certification token associated with the device 10 that was generated by means of this network address.

In a first example, such a message is a DHCP Release type message comprising the certification token CNT, the hash HASH_CNT of the certification token CNT, and the parameter TYP_HASH_CNT on how the hash HASH_CNT is calculated.

In a second example, the device 10 transmits a new type of message, called DHCP Revoke. Such a DHCP Revoke message also comprises the corresponding certification token CNT, the hash HASH_CNT of the certification token CNT, and the parameter TYP_HASH_CNT on how the hash HASH_CNT is calculated.

Upon receiving the DHCP Release or DHCP Revoke message, in a step H2, the configuration server 11 processes the information relating to the release of the network addresses included in this request in a conventional manner.

When processing the DHCP Release message, the configuration server 11 detecting the presence of parameters relating to the certificate CERT_CPE in a message field, that is to say at least the corresponding certification token CNT, or the hash HASH_CNT of the certification token CNT, see also and the parameter TYP_HASH_CNT on how the hash HASH_CNT is calculated, extracts this information and generates a request to revoke the certification token CNT associated with the device 10 and the certificate CERT_CPE.

When processing the DHCP Revoke message, the nature of the message itself indicates to the configuration server 11 that it must extract the parameters relating to the certificate CERT_CPE included in a field of the DHCP Revoke message, that is to say the corresponding certification token CNT, the hash HASH_CNT of the certification token CNT and the parameter TYP_HASH_CNT on how the hash HASH_CNT is calculated, and generate a request to revoke the certification token CNT associated with the device 10 and the certificate CERT_CPE.

In a second implementation, the revocation of the certification token CNT associated with the device 10 and the certificate CERT_CPE is initiated by the network, such a network change may also be detected and indicated by the radio access point to which the device 10 is attached, such as a base station or a Wi-Fi access point. In this second implementation, the transmission of the DHCP Release message or the DHCP Revoke message is initiated by the network and is triggered, for example, by the detection of inactivity of the device 10 by the network, the detection of a faulty routing of traffic from or to the device 10, the detection of a new association between a network address allocated to the device 10 and a new physical address (MAC, standing for “Medium Access Control”), etc.

The request to revoke the certification token CNT comprises: the corresponding certification token CNT, the hash HASH_CNT of the certification token CNT, the parameter TYP_HASH_CNT on how the hash HASH_CNT is calculated and the certificate CertDHCP associated with the configuration server 11. The request to revoke the certification token CNT may also comprise the domain name, for example “4d2a.37f78dd8d99b3c75ddde3624155.example.com”, with which the certificate CERT_CPE was associated during step E8 described with reference to FIG. 3A.

Regardless of the implementation implemented, the configuration server 11 transmits, in a step H3, the request to revoke the certification token CNT to the certificate management module 12.

Upon receiving the request to revoke the certification token CNT, the certificate management module 12 optionally proceeds, in a step H4, to verify the authenticity of the certification token CNT by means of the certificate CertDHCP associated with the configuration server 11.

Once the authenticity of the certification token CNT has been verified by means of the certificate CertDHCP associated with the configuration server 11, the certificate management module 12 removes the certificate CERT_CPE associated with the device 10 and the corresponding certification token CNT in a step H5. In the case where step H4 is not implemented, the execution of step H5 is triggered by the receipt of the request to revoke the certification token transmitted by the configuration server 11. Once this verification has been performed, the certificate management module 12 transmits, in a step H5, a request DRev for revoking the association of the certificate CERT_CPE associated with the device 10 with the domain name “4d2a.37f78dd8d99b3c75ddde3624155.example.com” with which the certificate CERT_CPE was associated during step E8 described with reference to FIG. 3A, to the domain name server 13.

Such a revocation request DRev comprises: the corresponding certification token CNT, the certificate CERT_CPE and the public key PUB_KEY_CM of the certificate management module 12.

At the same time, the management module 12 removes the certificate CERT_CPE and the corresponding certification token CNT from a database.

In a step H6, the domain name server 13 extracts all of the information included in the revocation request DRev and revokes the association established between, on the one hand, the certificate CERT_CPE and the corresponding certification token CNT and, on the other hand, the domain name “4d2a.37f78dd8d99b3c75ddde3624155.example.com”.

Once the association between the certificate CERT_CPE and the corresponding certification token CNT and the domain name has been revoked, the domain name server 13 informs the certificate management module 12 thereof in a step H7.

In a particular implementation, the operation of deleting the certificate CERT_CPE and the corresponding certification token CNT from a database of the management module 12 is triggered by the receipt of the information relating to the revocation of the association between the certificate CERT_CPE and the corresponding certification token CNT and the domain name received in step H7.

In turn, the certificate management module 12 informs the configuration server 11 of the revocation of the association between the certificate CERT_CPE and the corresponding certification token CNT and the domain name in a step H8.

At the end of step H8, the device 10 desiring to establish a connection with the server of a service provider 14 transmits to the latter a conventional client Hello TLS message, i.e. not comprising a certification token CNT since the latter has been revoked.

As the server of a service provider 14 does not find a certification token CNT in the Hello TLS message, it cannot verify the validity of any certificate relating to the device 10.

The server of a service provider 14 then transmits a Server Hello message to the device 10 indicating that the certificate associated with the device 10 is invalid and that a connection cannot be established with the device 10.

These exchanges of conventional client Hello TLS and Server Hello messages between the device 10 and the server 14 are not shown in FIG. 5.

If by chance, the device 10 needs to obtain a new certificate and the corresponding certification token, then it must implement steps E1 to E11 again.

FIG. 6 shows the various steps implemented by the various devices constituting the system described with reference to FIG. 2 in a second embodiment of the method for revoking a certification token CNT associated with the device 10.

The implementation of this revocation method may or may not occur following the execution of step G6 during which a connection is established between the device 10 and the server of a service provider 14.

In this second embodiment, the device 10 transmits, to the configuration server 11, a message requesting the release of the network address(es) allocated thereto during a step P1.

Sending such a message to the configuration server 11 may be triggered when the device 10 leaves the coverage area of a first access node, such as for example a Wi-Fi access node, to attach to a second access node such as a base station. The release of the network address allocated to the device 10 results in the revocation of the certification token associated with the device 10 that was generated by means of this network address.

In a first example, such a message is a DHCP Release type message comprising the certification token CNT, the hash HASH_CNT of the certification token CNT, and the parameter TYP_HASH_CNT on how the hash HASH_CNT is calculated.

Upon receiving the DHCP Release message, in a step P2, the configuration server 11 processes the information relating to the release of the network addresses included in this request in a conventional manner.

At a given time, intervening after the request to release the network address(es) allocated to the device 10 and without correlation with the transmission of this release request, the server of a service provider 14 transmits a request for resolution of domain names RQT-DNS to the domain name server 13, for example for the domain name “4d2a.37f78dd8d99b3c75ddde3624155.example.com” associated with the certificate CERT_CPE of the device 10, in a step P3.

When the domain name server 13 notices that the existing association between the domain name “4d2a.37f78dd8d99b3c75ddde3624155.example.com” and the certificate CERT_CPE has expired, the domain name server 13 transmits, in a step P4, an MSG-TTL message indicating that the existing association between the domain name “4d2a.37f78dd8d99b3c75ddde3624155.example.com” and the certificate CERT_CPE has expired to the certificate management module 12. Such an MSG-TTL message comprises at least the certification token CNT. For example, such an MSG-TTL message is implemented by adding a new id-pkix-ocsp-cnt message to the definition of the OCSP (Online Certificate Status Protocol) protocol as defined in ASN.1 in the document published at the following address: https://www.rfc-editor.org/rfc/rfc6960 #appendix-B.1:

An example of an MSG-TTL message waiting for a response containing a certification token CNT comprises an identification of the message type “id-pkix-ocsp-cn” in its “AcceptableResponses” field.

Upon reception of this MSG-TTL message, the certificate management module 12 transmits an MSG-Inf information message to the configuration server 11 informing it that the existing association between the domain name “4d2a.37f78dd8d99b3c75ddde3624155.example.com” and the certificate CERT_CPE has expired, in a step P5. For example, such an MSG-Inf message is implemented using the message compliant with the OCSP protocol instantiating a ‘ServiceLocator’ extension of the OCSP protocol (cf. section 4.4.6 of the document RFC6960 published by the IETF), such a message comprising identifiers of the configuration server 11 and of the certificate management module 12:

ServiceLocator := SEQUENCE {
issuer ‘172.3.2.1’,
locator ‘172.3.2.2’}

where the “service locator” field comprises either the network address ‘172.3.2.2’ of the configuration server 11 or its “common name” ‘srvcfg11.example.com’, and the “issuer” field comprises the network address 172.3.2.1′ or the identifier CN_CM of the certificate management module 12.

In response to the MSG-Inf message and knowing that the device 10 and, in a step P6, a request to revoke the certification token CNT intended for the certificate management module 12.

Such a revocation request comprises: the corresponding certification token CNT, the hash HASH_CNT of the certification token CNT, the parameter TYP_HASH_CNT on how the hash HASH_CNT is calculated, and the certificate CertDHCP associated with the configuration server 11. The request to revoke the certification token CNT may also comprise the domain name, for example “4d2a.37f78dd8d99b3c75ddde3624155.example.com”.

Upon receiving the request to revoke the CNT certification token, the certificate management module 12 optionally proceeds, in a step P7, to verify the authenticity of the certification token CNT by means of the certificate CertDHCP associated with the configuration server 11.

Once the authenticity of the certification token CNT has been verified by means of the certificate CertDHCP associated with the configuration server 11, the certificate management module 12 removes the certificate CERT_CPE associated with the device 10 and the corresponding certification token CNT in a step P8. In the case where step P7 is not implemented, the execution of step P8 is triggered by the receipt of the request to revoke the certification token transmitted by the configuration server 11.

Once this verification has been performed, the certificate management module 12 transmits, in a step P9, a request DRev for revoking the association of the certificate CERT_CPE associated with the device 10 with the domain name “4d2a.37f78dd8d99b3c75ddde3624155.example.com”, to the domain name server 13.

Such a revocation request DRev comprises: the corresponding certification token CNT, the certificate CERT_CPE and the public key PUB_KEY_CM of the certificate management module 12.

At the same time, the certificate management module 12 removes the certificate CERT_CPE and the corresponding certification token CNT from a database.

In a step P10, the domain name server 13 extracts all of the information included in the revocation request DRev and revokes the association established between, on the one hand, the certificate CERT_CPE and the corresponding certification token CNT and, on the other hand, the domain name “4d2a.37f78dd8d99b3c75ddde3624155.example.com”.

Once the association between the certificate CERT_CPE and the corresponding certification token CNT and the domain name has been revoked, the domain name server 13 informs the certificate management module 12 thereof in a step P11 which may be optional.

In a particular implementation, the operation of deleting the certificate CERT_CPE and the corresponding certification token CNT from a database of the management module 12 is triggered by the receipt of the information relating to the revocation of the association between the certificate CERT_CPE and the corresponding certification token CNT and the domain name received in step P11.

In turn, the certificate management module 12 optionally informs the configuration server 11 of the revocation of the association between the certificate CERT_CPE and the corresponding certification token CNT and the domain name in a step P12.

At the end of step P10, the device 10 desiring to establish a connection with the server of a service provider 14 transmits to the latter a conventional client Hello TLS message, i.e. not comprising a certification token CNT since the latter has been revoked.

As the server of a service provider 14 does not find a certification token CNT in the Hello TLS message, it cannot verify the validity of any certificate relating to the device 10.

The server of a service provider 14 then transmits a Server Hello message to the device 10 indicating that the certificate associated with the device 10 is invalid or does not allow identifying the device 10 and/or its service provider and that a connection cannot be established with the device 10.

These exchanges of conventional client Hello TLS and Server Hello messages between the device 10 and the server 14 are not shown in FIG. 5.

If by chance, the device 10 needs to obtain a new certificate and the corresponding certification token, then it must implement steps E1 to E11 again.

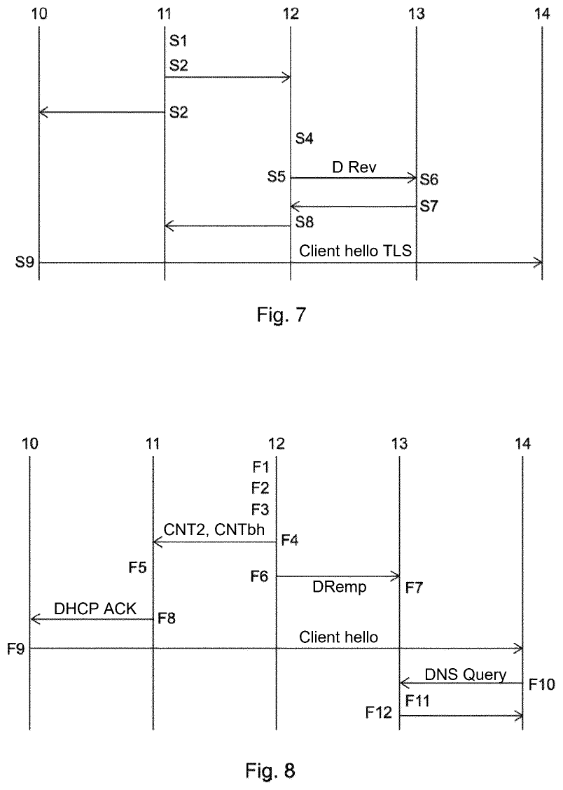

FIG. 7 shows the various steps implemented by the various devices constituting the system described with reference to FIG. 2 in a third embodiment of the method for revoking a certification token CNT associated with the device 10.

The implementation of this revocation method may or may not occur following the execution of step G6 during which a connection is established between the device 10 and the server of a service provider 14.

In a step S1, the expiry of a lifetime associated with one or more network addresses allocated to the device 10 triggers the release of these network addresses by the configuration server 11. In another example, the configuration server 11 receives a request to release the network addresses allocated to the device 10 following a decision of the network manager operator.

In a step S2, the configuration server 11 transmits a request to revoke the certification token CNT to the certificate management module 12. Such a revocation request comprises the certification token CNT and a code indicating the reasons for this suspension request.

Parallel to step S2, the configuration server 11 transmits a DHCP NACK message to the device 10 in a step S3. Such a DHCP NACK message indicates to the device 10 that it is no longer authorized to use the network addresses that were allocated thereto. The DHCP NACK message also comprising the certification token CNT, the device 10 also understands that it is no longer authorized to use this certification token CNT. Such a step S3 may occur in some embodiments prior to the implementation of step S2 or prior to the implementation of step S1.

Upon receiving the request to revoke the certification token CNT, the certificate management module 12 optionally proceeds, in a step S4, to verify the authenticity of the certification token CNT by means of the certificate CertDHCP associated with the configuration server 11.

Once this verification has been performed, the certificate management module 12 transmits, in a step S5, a request DRev for revoking the association of the certificate CERT_CPE associated the with device 10 with the domain name “4d2a.37f78dd8d99b3c75ddde3624155.example.com” with which the certificate CERT_CPE was associated during step E8 to the domain name server 13.

Such a revocation request DRev comprises at least the corresponding certification token CNT, and optionally the certificate CERT_CPE and the public key PUB_KEY_CM of the certificate management module 12. Such a revocation request also comprises the code indicating the reasons for this suspension request.

At the same time, the certificate management module 12 removes the certificate CERT_CPE and the corresponding certification token CNT from a database.

In a step S6, the domain name server 13 extracts all of the information included in the revocation request DRev and revokes the association established between, on the one hand, the certificate CERT_CPE and the corresponding certification token CNT and, on the other hand, the domain name “4d2a.37f78dd8d99b3c75ddde3624155.example.com”.

Once the association between the certificate CERT_CPE and the corresponding certification token CNT and the domain name has been revoked, the domain name server 13 informs the certificate management module 12 thereof in a step S7 which may be optional.

In a particular implementation, the operation of deleting the certificate CERT_CPE and the corresponding certification token CNT from a database of the management module 12 is triggered by the receipt of the information relating to the revocation of the association between the certificate CERT_CPE and the corresponding certification token CNT and the domain name received in step S7.

In turn, the certificate management module 12 optionally informs the configuration server 11 of the revocation of the association between the certificate CERT_CPE and the corresponding certification token CNT and the domain name in a step S8.

At the end of step S8, the device 10 desiring to establish a connection with the server of a service provider 14 transmits to the latter a conventional client Hello TLS message, i.e. not comprising a certification token CNT since the latter has been revoked in step S9.

These exchanges of conventional client Hello TLS and Server Hello messages between the device 10 and the server 14 are not shown in FIG. 5.

If by chance, the device 10 needs to obtain a new certificate and the corresponding certification token, then it must implement steps E1 to E11 again.

FIG. 8 shows the various steps implemented by the various devices constituting the system described with reference to FIG. 2 in a fourth embodiment of the method for revoking a certification token CNT associated with the device 10.

The implementation of this revocation method occurs following the execution of step G6 during which a connection is established between the device 10 and the server of a service provider 14.

In a step F1, the management module 12 receives a request to revoke a first certification token CNT1 associated with the device 10 from the network manager operator. Such a revocation request t may be transmitted for a plurality of reasons: the first certification token CNT1 is a temporary certification token that must be replaced because it is expiring, the first certification token CNT1 is corrupted or the corruption thereof is suspected, the first certification token CNT1 is pirated or the piracy thereof is suspected, etc.

In the example of implementation example described below, the revocation request comprises a request to replace the first certification token CNT1 associated with the device 10. Nevertheless, this fourth embodiment may apply to a request for revocation of a certification token not comprising a request for the replacement of the latter. Similarly, although the first, second, and third embodiments of the revocation method have been described with a request for revocation of a certification token not comprising a request for the replacement of the latter, they may of course process similarly to that described below with reference to the fourth embodiment, a request for revocation of a certification token comprising a request for the replacement of the latter.

In a step F2, the certificate management module 12 revokes the first certification token CNT1 and the corresponding first certificate CERT1_CPE.

In a step F3 performed before, after or concomitantly with step F2, the certificate management module 12 generates a second CERT2_CPE certificate associated with the device 10.

If the second certificate CERT2_CPE is a conventional certificate, the latter is generated from the following information: the public key PUB_KEY_CPE of the device 10, the hash HASH_CPE of a physical address of the device 10, a certificate CertDHCP associated with the configuration server 11, at least one network address IP_CPE allocated to said device 10 by the configuration server 11 during step E4 described with reference to FIG. 2 (or a pool of network addresses POOL_IP_CPE allocated to the device 10), and finally the parameter TYP_HASH on how the hash HASH_CPE is calculated.

If the certificate CERT2_CPE is a restricted-access certificate, or “black hole” certificate, it is generated from information not linked to the device 10 in order to isolate the latter.

Regardless of the type of certificate generated, the certificate management module 12 also generates a certification token CNT2 or CNTbh corresponding to the certificate CERT2_CPE associated with the device 10. Such a certification token CNT2, CNTbh is a compact form of the certificate CERT2_CPE associated with the device 10.

It is this certification token CNT2, CNTbh that will now be used by the device 10 in all situations where the latter must provide authentication hardware to access a service.

For this purpose, the management module 12 transmits, during a step F4, the second certification token CNT2, CNTbh to the configuration server 11 so that the latter replaces the first certification token CNT1 associated with the device 10 with the second certification token CNT2, CNTbh.

In a particular implementation, the reception of the second certification token CNTbh by the configuration server 11 triggers, in a step F5, the allocation of a new network address, known as the “black hole” address, to the device 10. The use of such a “black hole” address in the exchanges from or to the device 10 allows isolating the data exchanged by the device 10 with other devices and in particular the server of a service provider 14. More particularly, the data transmitted from or to the device 10 by means of this “black hole” address may in a first case not be delivered or be delivered to a server emulating the server of a service provider 14, in a second case be routed to a dedicated device in order to study them in order to confirm the corruption of the device 10.

Parallel to the execution of step F4, the management module 12 transmits, in a step F6, a request DRemp to revoke the certificate CERT1_CPE associated with the device 10 with the domain name “4d2a.37f78dd8d99b3c75ddde3624155.example.com”, this request requesting the deletion of the association established between, on the one hand, the certificate CERT1_CPE and the corresponding certification token CNT1 and, on the other hand, the domain name “4d2a.37f78dd8d99b3c75ddde3624155.example.com” and the replacement thereof by the second certificate CERT2_CPE to the domain name server 13.

Such a revocation request DRemp comprises: the first certification token CNT1, the first certificate CERT1_CPE, the second certification token CNT2, CNTbh, the second certificate CERT2_CPE and the public key PUB_KEY_CM of the certificate management module 12.

At the same time, the management module 12 stores in a database that the first certificate CERT1_CPE and the corresponding first certification token CNT1 are revoked and replaced by the second certificate CERT2_CPE and the corresponding second certification token CNT2, called CNTbh.

In a step F7, the domain name server 13 extracts all of the information included in the revocation request DRemp, revokes the association of the first certificate CERT1_CPE and the corresponding first certification token CNT1 with the domain name “4d2a.37f78dd8d99b3c75ddde3624155.example.com” and proceeds with the association of the domain name “4d2a.37f78dd8d99b3c75ddde3624155.example.com” with the second certificate CERT2_CPE and the corresponding second certification token CNT2, CNTbh.

In a step F8 that can be implemented before, after or at the same time as steps F6 and F7, the configuration server 11 transmits a DHCP ACK message to the device 10. Such a DHCP ACK message comprises the second certification token CNT2, CNTbh. The DHCP ACK message comprising the second certification token CNT2, CNTbh, the device 10 understands that it is no longer authorized to use the first certification token CNT1 that has been revoked and that it must now use the second certification token CNT2, CNTbh. If step F5 was implemented by the configuration server 11, then the DHCP ACK message also comprises the “black hole” address.

At the end of step F8, the device 10 desiring to establish a connection with the server of a service provider 14, because the connection established at the end of step G6 was interrupted, transmits to the latter a client Hello message comprising the certification token CNT2, CNTbh in a step F9.

Upon reception of this client Hello TLS message, the server of a service provider 14 transmits a DNS Query type message comprising the certification token CNT2, CNTbh to the domain name server 13 in a step F10.

The domain name server 13 then verifies, during a step F11, the validity of the certification token CNT2, CNTbh and resends, during a step F12, a message indicating that the certification token CNT2, CNTbh is valid but that it does not offer restricted access to the resources of the server of a service provider 14.

Afterwards, the server of a service provider 14 transmits a Server Hello message to the device 10 indicating that the certificate associated with the device 10 is valid and indicating that access to its resources is restricted, thereby establishing a connection with the device 10.

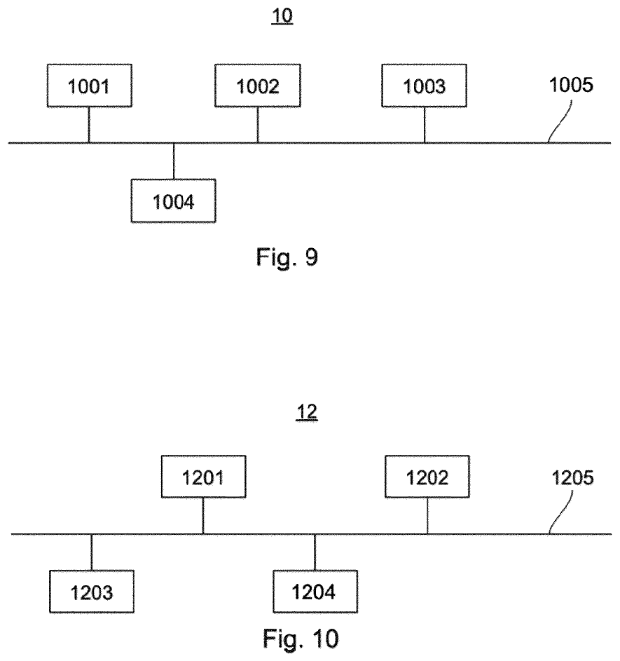

FIG. 9 shows a device 10 capable of implementing the method for authenticating a connection between a device connected to at least one communication network and a server of a service provider object of the present development.

A device 10 may comprise at least one hardware processor 1001, a storage unit 1002, an interface 1003 and at least one network interface 1004 that are connected together through a bus 1005. Of course, the elements constituting the device 10 can be connected by means of a connection other than a bus.

The processor 1001 controls the operations of the device 10. The storage unit 1002 stores at least one program for implementing the various methods object of the development to be executed by the processor 1001, and various data, such as parameters used for calculations performed by the processor 1001, intermediate data of calculations performed by the processor 1001, etc. The processor 1001 may be formed of any known and suitable hardware or software, or of a combination of hardware and software. For example, the processor 1001 may be formed by dedicated hardware such as a processing circuit, or by a programmable processing unit such as a central processing unit (Central Processing Unit) which executes a program stored in a memory of the latter.

The storage unit 1002 can be formed by any suitable means able to store the program(s) and data in a manner that can be read by a computer. Examples of storage unit 1002 comprise computer-readable non-transient storage media such as semiconductor memory devices, and magnetic, optical or magneto-optical recording media loaded in a read-and-write unit.

The interface 1003 provides an interface between the device 10 and a network address configuration server 11.

The network interface 1004 in turn provides a connection between the device 10 and at least one server of a service provider with which it desires to establish an authenticated connection.

FIG. 10 shows a management module 12 capable of implementing the various methods object of the present development.

A management module 12 may comprise at least one hardware processor 1201, a storage unit 1202, an interface 1203 and at least one network interface 1204 that are connected together through a bus 1205. Of course, the elements constituting the management module 12 can be connected by means of a connection other than a bus. In one embodiment, the certificate management module 12 is embedded in the configuration server 11.

The processor 1201 controls the operations of the management module 12. The storage unit 1202 stores at least one program for implementing various methods object of the development to be executed by the processor 1201, and various data, such as parameters used for calculations performed by the processor 1201, intermediate data of calculations performed by the processor 1201, etc. The processor 1201 may be formed of any known and suitable hardware or software, or of a combination of hardware and software. For example, the processor 1201 may be formed by dedicated hardware such as a processing circuit, or by a programmable processing unit such as a central processing unit (Central Processing Unit) which executes a program stored in a memory of the latter.

The storage unit 1202 can be formed by any suitable means able to store the program(s) and data in a manner that can be read by a computer. Examples of a storage unit 1202 comprise computer-readable non-transient storage media such as semiconductor memory devices, and magnetic, optical or magneto-optical recording media loaded in a read-and-write unit.

The interface 1203 provides an interface between the management module 12 and at least one device 10 desiring to connect to a communication network.

The network interface 1204 in turn provides a connection between the management module 12 and a domain name server 13.

1. A method for revoking a first certification token corresponding to a first certificate, the first certification token for authenticating the establishment of a connection between a device connected to at least one communication network and at least one server of a service provider, the first certification token and the first certificate being generated from a hash of a physical address of the device, a certificate associated with a network address configuration server and at least one network address allocated to the device by the network address configuration server, the method comprising the following implemented by a certificate management module:
revoking the first certification token triggered by obtaining information relating to a condition to revoke the first certification token; and
transmitting, to a domain name server, a revocation request of an association established between on the one hand the first certificate and the first certification token and on the other hand at least one domain name.

2. The method for revoking a certification token according to claim 1, wherein the condition for revoking the first certification token belongs to a group comprising:
a request to revoke the first certification token, the revocation request being transmitted by the device,
a request to revoke the first certification token, the revocation request being transmitted by a device of the network,
an expiry of an allocation period of the network address allocated to the device,
an expiry of a lifetime of the first certification token,
an expiry of a duration of the association established between, on the one hand, the first certificate and the first certification token and, on the other hand, at least one domain name,
a conflict of use in an addressing plan,
information relating to a compromise of the first certification token,
information relating to a piracy of the first certification token.

3. The method for revoking a certification token according to claim 2, which, when the information relating to a condition to revoke the first certificate is information relating to the expiry of the duration of the association established between, on the one hand, the first certificate and the first certification token and, on the other hand, at least one domain name, comprises, prior to revoking the first certification token, the following:
transmitting a request to revoke an association established between, on the one hand, the first certificate and the first certification token and, on the other hand, the network address configuration server; and
receiving a request to revoke the first certification token transmitted by the network address configuration server following the revocation of the association established between, on the one hand, the first certificate and the first certification token and, on the other hand, the network address configuration server.

4. The method for revoking a certification token according to claim 3, further comprising transmitting, to the network address configuration server, a message acknowledging the revocation of the first certification token by the certificate management module.

5. The method for revoking a certification token according to claim 1 further comprising the following when the condition for revoking the first certification token is accompanied by a request to replace the first certification token:
generating a second certificate associated with the device and a corresponding second certification token;
transmitting, to the domain name server, a request for association between, on the one hand, the second certificate and the second certification token and, on the other hand, the domain name previously associated with the first certificate and with the corresponding first certification token; and
transmitting the second certification token to the device.

6. The method for revoking a certification token according to claim 5, wherein the second certification token provides restricted access to the server resources of a service provider.

7. A certificate management module adapted to revoke a first certification token corresponding to a first certificate, the first certification token for authenticating the establishment of a connection between a device connected to at least one communication network and at least one server of a service provider, the first certification token and the first certificate being generated by the certificate management module from a hash of a physical address of the device, a certificate associated with a network address configuration server and at least one network address allocated to the device by the network address configuration server, the certificate management module comprising at least one processor configured to:
revoke the first certification token following obtaining information relating to a condition to revoke the first certification token; and
transmit, to a domain name server, a revocation request of an association established between, on the one hand, the first certificate and the first certification token and, on the other hand, at least one domain name.

8. A network address configuration server comprising at least one certificate management module adapted to revoke a first certification token corresponding to a first certificate, the first certification token for authenticating the establishment of a connection between a device connected to at least one communication network and at least one server of a service provider, the first certification token and the first certificate being generated by the certificate management module from a hash of a physical address of the device, a certificate associated with the network address configuration server and at least one network address allocated to the device by the network address configuration server, the certificate management module comprising at least one processor configured to:
revoke the first certification token following obtaining information relating to a condition to revoke the first certification token; and
transmit, to a domain name server, a revocation request of an association established between, on the one hand, the first certificate and the first certification token and, on the other hand, at least one domain name.

9. A processing circuit comprising a processor and a memory, the memory storing program code instructions of a computer program to execute the method for revoking a first certification token according to claim 1, when the computer program is executed by the processor.
